(19) United States
(12) Patent Application Publication
(10) Pub. No.: US 2011/0132708 A1
(43) Pub. Date: Jun. 9, 2011

(54) Flexible luggage organizer

(76) Inventors: Jonathan E. DeLine, Oak Ridge, NC (US); Deborah A. DeLine, Oak Ridge, NC (US)

(21) Appl. No.: 12/592,886

(22) Filed: Dec. 4, 2009

(51) Int. Cl. A45C 5/14; G09F 3/00; A45C 13/00; A45C 3/00

(52) U.S. Cl. 190/18 A; 40/299.01; 190/115; 190/109

(57) ABSTRACT

A device for organizing around the collapsible handle of wheeled luggage, baggage or containers the most personal, important, or frequently used items during travel is disclosed, which includes a bag that attaches to the collapsible handle of luggage and uses the handle as a skeleton frame to create a securing structure for those items without inhibiting the operation of the collapsible handle. The bag is fully accessible and convenient by its close proximity to the users hand when the handle is in its extended position. In either position, the device offers an increased opportunity for branding, personalization and identification for the end user. When the device is removed from the handle it can be stowed in a convenient configuration, such as a tri-fold, for storage or hung within convenient reach to the user to allow continued access to the items being stored.

### FIELD OF THE INVENTION

The present invention relates to the field of wheeled luggage, briefcases, baggage and portable container constructions in general and more particularly to a device that can utilize the existing features or structure of such luggage to provide additional storage, convenience, and identification to enhance the usefulness of such constructions.

### BACKGROUND OF THE INVENTION

Developments in luggage, luggage carts, baggage, containers, and other carrying devices have included an extendable and retractable handle coupled with wheels or rollers to allow consumers to pull their baggage with less effort than carrying it by a fixed handle. This configuration has allowed the user to tilt baggage and exert a forward or backward motion in a one handed, convenient fashion. The distance between the hand and the main baggage compartment, the primary method for storing and organizing items, creates an inconvenience for travelers who must turn the luggage upright, bend over, and access any items of convenience that may be stowed in the main baggage compartment. It is often desirable for users to have such items either closer to the hand that is pulling the baggage or in a more easily accessible location for quick and frequent access. Currently, users must grasp such items in an awkward manner, many times with the same hand that is guiding and steering the extendable/retractable handle. The extendable, retractable, or foldable handle (hereby referred to as, “collapsible handle”) has created a space above the luggage by which other items may be held or stored. Other inventions are specific to creating suspension systems for holding objects planar and perpendicular to gravity, which are more specific to beverages, allowing them to swing inside the collapsible handle structure. These inventions have shortcomings because the articles contained inside the structure swing excessively, prohibit the handling of extra luggage against the opposite side of the collapsible handle, and have a need to be better supported. Furthermore, these inventions remain clumsy and awkwardly exposed when the handle is in its collapsed position, often forcing the user detach and stow the structure. The need arises to create a more rigid structure by utilizing the existing handle structure and collapses away automatically without inhibiting the handle's operation. Current methods of storing other bags around this space involve a separate strap, the user holding both baggage handles simultaneously, or that the bag being held include an extra loop that slides over the collapsible handle. These methods do not allow the user easy and frequently access to necessary or convenient items used while traveling. While these current methods allow for storage of a second bag, they do not explicitly provide a fit for purpose bag that functions to organize frequently used items around the space created around the collapsible handle in such a way that allows for the user to conveniently access items of most importance or most frequent use while maintaining the necessary structure to support such items. Such a device may still allow for storage of a second bag.

While current methods allow for the user to carry a second bag or organizer, loosely supported by the collapsible handle, the structure inhibits the extension and retraction of the handle. This requires the user to remove and stow the extra bag before operating the handle. In most cases, it becomes necessary for the structure that supports and organizes items of travel to remain intact yet still allow the normal operation of the collapsible handle.
Furthermore, a number of solutions exist to brand, personalize, and identify luggage as an add-on accessory. These devices typically are constructed of a semi rigid structure and fastening method which is subject to damage during the transportation of baggage. It becomes advantageous for the organizing structure that collapses with the handle remain as a flexible, durable structure capable of branding, personalizing, or identifying during transportation for the sake of convenience and security.
Finally, existing bags that are held in conjunction with the collapsible handle through a loop on the extra bag are not designed to allow for the rapid staging and presentation of necessary items to move quickly through areas of public transportation and security. They also are not designed to keep the most valuable or most frequently used items accessible throughout the duration of travel because they are not specifically designed to fit with or utilize existing, common structures found in luggage, baggage or containers. This presents a need to allow items that are necessary to pass through defined zones or areas in a more expedient and convenient manner while allowing for the convenient attachment and accessibility during transportation while allowing detachment and storage for when the device is not in use.

### SUMMARY OF THE INVENTION

The present invention recognizes and addresses disadvantages of prior art constructions and methods, and it is an object of the present invention to provide a device that utilizes the structure of, and area around the collapsible handle to organize items needed or used frequently while traveling in a convenient manner. Storage on the device is specifically designed to present the most personal, important, or frequently used items during traveling to remain secure and accessible to the end user. The storage layout can help the user think through the inspection and security process normally incurred during travel to have access to items right when they need them. Furthermore, the empty structure collapses with the handle and acts as a robust method of identification. In this embodiment, the user can rapidly disconnect the structure and carry the items stored in a convenient, tri-fold configuration. This flexible, organizing device may be integral to the construction of the primary suitcase or, in this embodiment a secondary bag that attaches around the collapsible handle.

### BRIEF DESCRIPTION OF THE DRAWINGS

A full and enabling disclosure of the present invention, including the best mode thereof directed to one of ordinary skill in the art, is set forth in the specification, which refers to the appended FIG. 1-5, in which:

FIG. 1 is a front view of a piece of luggage which has a flexible device pulled over the collapsible handle

FIG. 2 is a side view of the collapsible handle highlighting the quick connect method of detaching the structure to slide off FIG. 3 is a rear view highlighting additional storage and accessibility

FIG. 4 is a collapsed handle with the flexible structure still attached highlighting the potential for identification

FIG. 5 is an alternative embodiment where the structure does not involve the extending rods but is created with tension between the collapsible handle in its extended position and the top handle of the main compartment

Repeat use of reference characters in the present specification and drawings is intended to represent same or analogous features or elements of the invention.

### DETAILED DESCRIPTION OF THE INVENTION

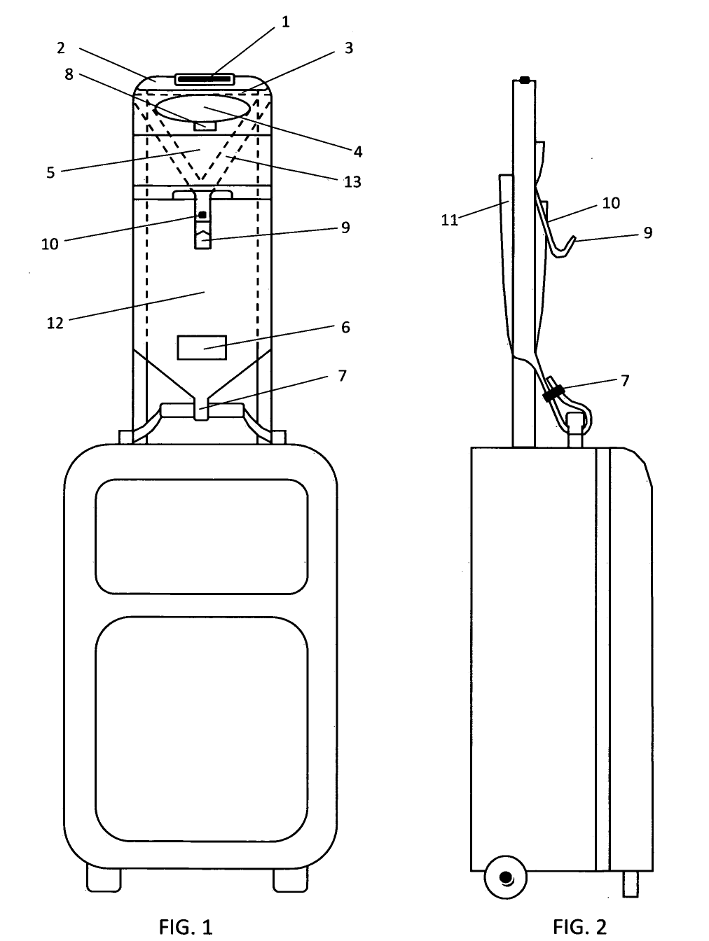

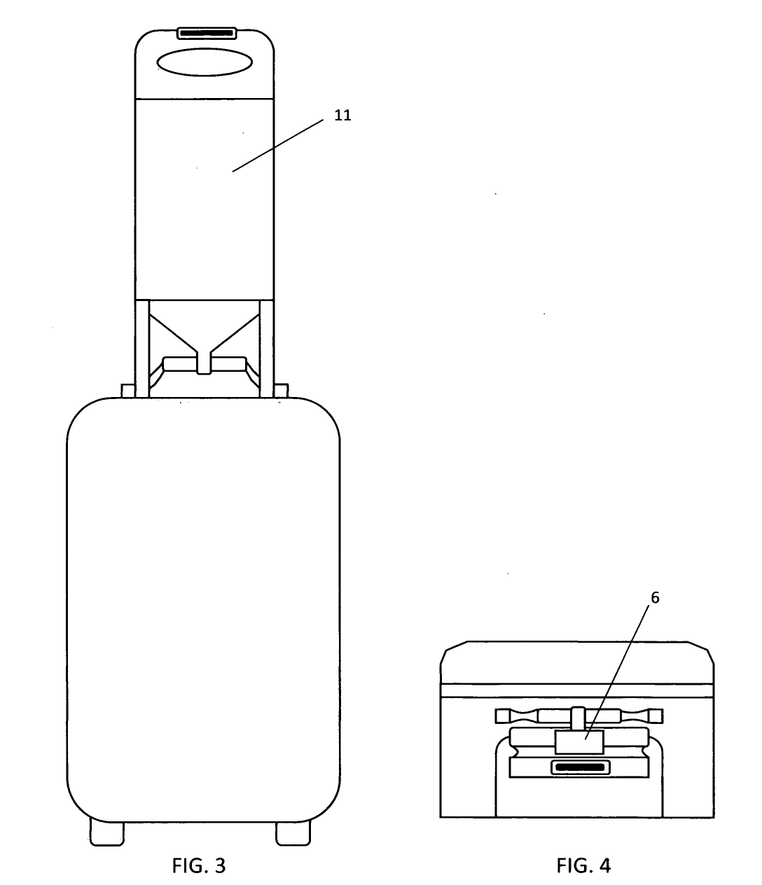

One of ordinary skill in the art will understand that the present discussion is a description of exemplary embodiments only, and is not intended as limiting the broader aspects of the present invention, which broader aspects are embodied in the exemplary construction. A repeat use of reference characters in the present specification and drawings represents the same or analogous features or elements of the invention. The device is fabricated by fixing together two pieces of flexible material, or both rigid and flexible material in a variety of configurations, such as spandex, nylon, polyester, polyethylene, recycled cardboard, cotton, rubber, latex, etc. and slides over the collapsible handle while it is in its extended position (see FIG. 1). An alternative configuration could be constructed of a light weight, non-flexible material such as rip stop nylon, and spandex together such that the rip stop nylon slides and collapses easier against the retracting rods of the collapsible handle. Provisions are made to allow clearance to existing levers that activate the collapsible handle (see FIG. 1, Ref # 1). Sewn, glued, heat-bonded or otherwise adhered into the fabric (or other flexible material) is an optional soft, ergonomic material, such as gel, rubber, extra fabric, leather, etc., as shown in FIG. 1, Ref # 2, which enhances the comfort of the end user while grasping the handle (FIG. 1, Ref. # 3). An optional internal frame may rest inside the soft material as a sub assembly that keeps the width when the device is pulled off of the collapsible handle. Provisions are made for the hand to pass through the structure in an ergonomically designed opening (see FIG. 1, Ref. # 4) when gripping the handle (FIG. 1, Ref. # 3). A fastener, such as a snap, Velcro, zipper, magnet, clasp, buckle, etc., is optionally present to keep items from falling down between the two pieces of fabric (FIG. 1, Ref # 8). Organizing pockets (FIG. 1, Ref #5 & #12) constructed of flexible material are sewn or otherwise attached onto the panels of material to create storage for items of travel (such as mobile phones, pens, passports, tickets, books, magazines, newspapers, papers, money, receipts, credit cards, loyalty cards, drivers license, etc.). In an alternative construction, these pockets may wrap around the structure and share a common fixing point so they do not add unnecessary tension to the structure and thereby inhibit the operation of the collapsible handle. These pockets may be sealed to provide extra security by a known fastening method (Velcro, zipper, snap, clasp, magnet, buckle, etc.). The ability to reduce the stretched fabrics force on the extending rods of the collapsible handle may consist of adjusting loops, zippers, Velcro, rope cinch, etc. to cover a variety of widths commonly found across collapsible handles without binding the material to the extending rods of the collapsible handle during operation. A pocket with a clear window (FIG. 1, Ref. # 6 also in FIG. 4 as Ref # 6) can contain removable or fixed identification for the owner. This feature remains accessible and readable even when the collapsible handle (FIG. 1, Ref # 3) is in the retracted position (see FIG. 4). A quick release fastener (such as a snap, zipper, belt, buckle, cinch, Velcro, clasp, carabineer, spring clip, etc) shown as Ref # 7 in FIGS. 1 and 2, is sewn or otherwise attached to the main fabric body with more rigid material (such as Rope, Nylon, Cordura, etc.) capable of attaching and detaching from the existing handle found on the top of luggage, baggage and containers with collapsible handles. This allows the flexible material to stretch across the collapsible handle, providing adequate tension and structure, while keeping the structure out of the way for the collapsible handle to retract into its collapsed position. These, “anchoring arms”, here within referred to as, “anchoring structure”, are adjustable in length to cover a variety of distances and variability to the existing handle. Furthermore, the number of these anchoring arms, or what they may attach to can vary depending on which type of bag they are being anchored to. An optional loop and hook/clasp (FIG. 1, Ref. # 9) can be fed through or sewn on the anchoring structure to grasp additional bags that may ride on the outside of the luggage and provide security to the collapsible handle. If desired, the flexible organizer can be removed from the luggage and carried into the mode of transportation and easily and accessibly stored by hanging it on to places like an airplane seatback pocket using the optional loop (FIGS. 1 & 2, Ref. # 9) by rotating it upward. An adjusting mechanism (FIG. 1, Ref # 10) is used to lengthen or shorten the loop depending on the height of the additional baggage with respect to the main luggage body. The loop is supported by following or being attached to the inside wall (FIG. 1, Ref # 13) of the fabric (or other flexible material) and anchored by wrapping around the top of the handle. Longer pockets (Ref # 11) shown in FIGS. 2 and 3 are sewn or otherwise attached into the main fabric (or flexible material) with elastic features to hold items of deeper construction (such as bottles, containers, umbrellas, magazines, newspapers, tickets, etc.). Furthermore, the device of this construction may be used for branding, identification, personalization, or safety (such as reflective material). Branding, personalization, and identification can be present on any surface, much like a billboard, like across Ref # 11, 12. Furthermore, the entire fabric or flexible material can be made of many colors or patterns to allow for the owner to customize and personalize the device.

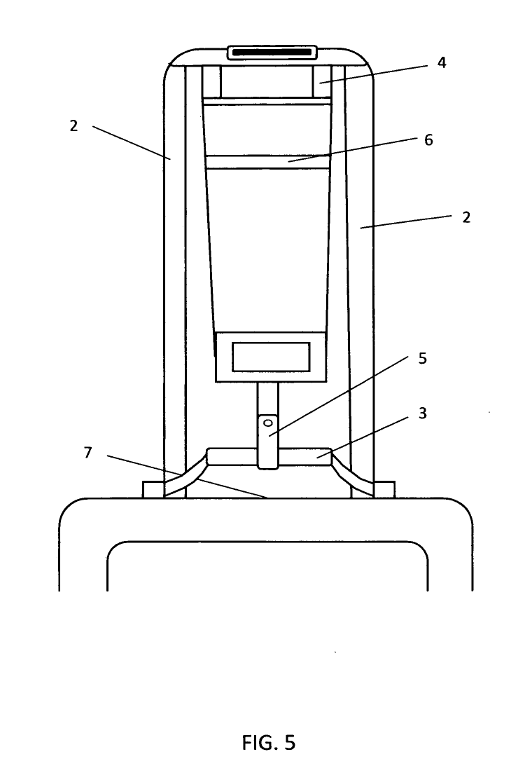

FIG. 5 shows an additional embodiment of the device which utilizes only the tension created from attaching the device between the extended handle and the top handle to create the primary carrying structure and organization for, or containment of, items used during travel. This alternative embodiment is constructed of flexible, or a combination of rigid and flexible structures to be attached to the top handle (FIG. 5, Ref # 1) and span across the open space between retractable rods (FIG. 5, Ref # 2) and the top handle of the main compartment (FIG. 5, Ref. # 3). This configuration allows for one-size-fits-all usage across a multitude of collapsible handles which vary by width, length, and collapsing/retracting method by creating structure independent of the retractable rods. For collapsible handles that vary in length, the connecting arm(s) (FIG. 5, Ref. # 4) have adjustability in length through extendible loops, Velcro, snaps, fasteners, belts, buckles, etc. to create the necessary tension of the structure. This same flexibility may be present in the connecting arms that fix themselves to the handle (FIG. 5, Ref. # 5) and allow the distance between the handle and the main body (FIG. 5, Ref. # 6) to be adjusted and set by the user. Since the top handle of the main compartment is typically found orientated toward the front of the compartment compared to the collapsed handle, the device tends to reside on the surface (see FIG. 5, Ref. # 7) between the collapsed handle and the retracted handle when the handle is in its collapsed position. By not attaching to the retracting rods (FIG. 5, Ref. # 2), this configuration performs its primary duties as an organizing structure fit for personalization, branding, and identification without touching or inhibiting the retracting rods while the handle is collapsing.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole and in part. Furthermore, those of ordinary skill in the art will appreciate that the foregoing description is by way of example only, and is not intended to limit the invention so further described in such appended claims. Therefore, the spirit and scope of the appended claims should not be limited to the description of the preferred versions contained therein.

What we claim is:

1. A device that gains its structure by stretching over the collapsible handle and retracting rods found on wheeled bags to create storage for organizing, housing, carrying, and protecting more accessible items.

2. A device that gains its structure by stretching between the collapsible handle and existing handle found on the main body of wheeled bags to create storage for organizing, housing, carrying, and protecting more accessible items.

3. The device to remain attached without inhibiting the operation of the collapsible handle.

4. The ability to use such a device as a means of advertisement, branding, personalization, or identification.
